(19) United States
(12) Patent Application Publication
(10) Pub. No.: US 2019/0226750 A1
(43) Pub. Date: Jul. 25, 2019

(54) REFRIGERATOR PLANAR HEATING ELEMENT AND HEATING CONTROL METHOD THEREFOR

(71) Applicant: PARU CO., LTD., Jeollanam-do (KR)

(72) Inventors: Moon Sig KANG, Jeollanam-do (KR); Jun Seok KIM, Jeollanam-do (KR); Gwang Yong LEE, Jeollanam-do (KR); Da Ae KIM, Jeollanam-do (KR); Woo Kyu LEE, Jeollanam-do (KR); Hyun Ah LEE, Sejong-si (KR)

(21) Appl. No.: 16/314,272

(22) PCT Filed: Jun. 9, 2017
(86) PCT No.: PCT/KR2017/005985

§ 371 Date: Dec. 28, 2018

(30) Foreign Application Priority Data
Sep. 8, 2016 (KR) 10-2016-0115463

(51) Int. Cl. F25D 21/02; F25D 21/08; H05B 1/02; H05B 3/03; H05B 3/26

(52) U.S. Cl. CPC F25D 21/02; F25D 21/08; H05B 1/0294; H05B 3/03; H05B 2203/032; H05B 2203/005; H05B 2203/013; H05B 2203/017; H05B 3/26

(57) ABSTRACT

A refrigerator planar heating element is arranged inside a refrigerator to radiate heat. The refrigerator planar heating element includes a defrosting planar heating element including a first substrate having one surface on which a first pattern for radiating heat is printed with conductive ink, a second substrate having one surface on which a second pattern for radiating heat and having the same form as the pattern of the first substrate is printed with conductive ink, and an adhesive layer performing bonding such that the patterns of the first substrate and the second substrate are overlapped in a vertical direction. The invention has heating performance more excellent than that of conventional heating elements, and applies an inverse current patterning technique so as to make a current flow in opposite directions at both surfaces of a substrate, thereby effectively shielding electromagnetic waves.

### TECHNICAL FIELD

The present invention relates to a planar heating element and, more particularly, to a planar heating element for a refrigerator, in which it is necessary to generate heat at a predetermined temperature to remove frost or prevent dew condensation, the planar heating element being fabricated by printed electronics technology to be used as a heat source in the refrigerator, and a heating control method therefor.

### BACKGROUND ART

In general, an evaporator of a refrigerator is subjected to frosting of moisture let into the refrigerator during opening and closing of the refrigerator. Frost folioed as above may disturb the proper operation of the evaporator, such that, for example, the temperature of the refrigerator may not be properly controlled, thereby having an adverse effect on the performance of the refrigerator. Accordingly, a refrigerator is provided with a defrosting heater disposed around an evaporator to periodically remove frost.

Such a defrosting heater generates heat, operated under the control of a controller, in order to melt frost.

That is, a defrosting method generally used in refrigerators is designed to directly remove frost formed on the surface of an evaporator using radiation heat generated during operation of a defrost heater. The defrost heater is operated for a previously-input period, under the control of a controller, to remove thick frost formed on the surface of the evaporator.

Such a defrost device is in the shape of a pipe through which high-temperature and high-pressure gas passes in order to remove frost formed on an evaporator or is provided with a tube heater disposed adjacent to an evaporator to remove frost.

In the case of defrosting using the defrost device of the related art, the defrost device may have the following problems. The defrost device may excessively operate even in the case in which no frost is formed or the amount of frost does not have a significant effect on the performance of refrigeration, so that a fire may occur in some cases. In addition, the defrost device may not rapidly operate in the formation of frost, thereby unnecessarily increasing power consumption.

In addition, a door of a refrigerator may be provided with a home bar allowing foods to be stored and taken out without opening of the door.

Such a home bar may include a home bar case connected to a refrigerator door and having an open area in one portion thereof and a home bar door configured to open and close the open area of the home bar case.

However, such a refrigerator of the related art is provided with an electric heater to prevent dew condensation on the surface of the home bar case. The electric heater increases power consumption, which is problematic.

In addition, heat generated by the electric heater enters a chamber of a refrigerator body, i.e. a freezing chamber or a refrigerating chamber, thereby causing the temperature inside the chamber to rise.

### DISCLOSURE

### Technical Problem

Accordingly, the present invention has been made keeping in mind the above problems occurring in the prior art, and an object of the present invention is to provide a planar heating element for a refrigerator, the planar heating element being able to be used in an evaporator as a heat source.

Another object of the present invention is to provide a planar heating element for a refrigerator, the planar heating element being able to be used in a home bar as a heat source.

A further object of the present invention is to provide a planar heating element for a refrigerator, the planar heating element being able to be used in a box-shaped refrigerator as a heat source.

Another object of the present invention is to provide a planar heating element for a refrigerator, the planar heating element being able to operate with lower power than other heating lines.

A further object of the present invention is to provide a planar heating element for a refrigerator, the planar heating element being able to provide surface heating rather than local heating.

Another object of the present invention is to provide a planar heating element for a refrigerator, the planar heating element being implemented as a film comprised of silver (Ag) nano ink.

A further object of the present invention is to provide a planar heating element for a refrigerator, the planar heating element blocking magnetic waves using reverse current patterning technology.

In addition, another object of the present invention is to provide a planar heating element for a refrigerator, the planar heating element being able to function as a fuse when heated to a predetermined temperature or higher.

### Technical Solution

In order to accomplish the above object, a planar heating element for a refrigerator is provided within the refrigerator to generate heat using electric power externally supplied by a power supply, and may include a defrosting planar heating element. The defrosting planar heating element includes: a first substrate having a first pattern printed on one surface thereof with conductive ink, the first pattern generating heat in response to electric power supplied by the power supply a second substrate having a second pattern printed on one surface thereof with conductive ink, the second pattern having a same configuration as the first pattern and generating heat in response to electric power supplied by the power supply; and an adhesive layer bonding the first substrate and the second substrate to each other such that the pattern of the first substrate overlaps the pattern of the second substrate in a top-bottom direction.

In addition, the planar heating element preferably includes: a first electrode including a positive (+) electrode electrically connected to one end of the first pattern and a negative (−) electrode electrically connected to the other end of the first pattern; and a second electrode including a positive (+) electrode electrically connected to one end of second pattern and a negative (−) electrode electrically connected to the other end of the second pattern, wherein the first electrode and the second electrode are provided in same positions of the substrates.

The defrosting planar heating element is located on a top surface or a bottom surface of an evaporator, one end of the first pattern being connected to the positive (+) electrode of the first electrode, the other end of the first pattern extends along a shape of a bottom of the evaporator to be connected to the negative (−) electrode of the first electrode, one end of the second pattern being connected to the positive (+) electrode of the second electrode, and the other end of the second pattern extends along the shape of the bottom of the evaporator to be connected to the negative (−) electrode of the second electrode, wherein, when a portion of either a shape of the first substrate or a shape of the second substrate has an area able to accommodate two or more portions of the pattern, the portions of the pattern are alternately arranged without interruption.

In addition, the planar heating element may further include a planar heating element for a home bar. The planar heating element for a home bar includes: a third substrate having a third pattern printed on one surface thereof with conductive ink, the third pattern generating heat in response to electric power supplied by the power supply; a fourth substrate having a fourth pattern printed on one surface thereof with conductive ink, the fourth pattern having a same configuration as the third pattern and generating heat in response to electric power supplied by the power supply; and an adhesive layer bonding the third substrate and the fourth substrate to each other such that the pattern of the third substrate overlaps the pattern of the fourth substrate in a top-bottom direction.

The first pattern, the second pattern, the third pattern, and the fourth pattern are printed using a roll-to-roll gravure printing machine. The roll-to-roll gravure printing machine includes: a feed roller supplying a rolled substrate; a plate roller printing a negative pattern on one surface of the substrate supplied by the feed roller; and an ink injector applying conductive ink on the negative pattern produced by the plate roller.

The planar heating element for a refrigerator is provided within the refrigerator to generate heat using electric power externally supplied by a power supply, and further includes a defrosting planar heating element. The defrosting planar heating element includes a first pattern printed on one surface of a first substrate with conductive ink, the first pattern generating heat in response to electric power supplied by the power supply, and a second pattern printed on the other surface of the first substrate with conductive ink, the second pattern having a same configuration as the first pattern.

In addition, the planar heating element may further include a planar heating element for a home bar. The planar heating element for home bar includes a third pattern printed on one surface of a second substrate with conductive ink, the third pattern generating heat in response to electric power supplied by the power supply, and a fourth pattern printed on the other surface of the second substrate with conductive ink, the fourth pattern having a same configuration as the third pattern.

Here, the first pattern, the second pattern, the third pattern, and the fourth pattern are printed using a roll-to-roll gravure printing machine. The roll-to-roll gravure printing machine includes: a feed roller supplying a rolled substrate; a first plate roller printing a negative pattern on one surface of the substrate supplied by the feed roller; a first ink injector applying conductive ink on the negative pattern produced by the first plate roller; a second plate roller printing a negative pattern on the other surface of the substrate supplied by the feed roller in a reversed position; and a second ink injector applying conductive ink on the negative pattern produced by the second plate roller.

Each of the patterns may be configured to be broken when the substrate thereof thermally deflects, thereby functioning as a fuse.

In addition, provided is a heating control method for a planar heating element for a refrigerator, the heating control method removing frost by driving the planar heating element according to whether or not frost is detected by a frost sensor. The heating control method may include: (a) a step of detecting, by the frost sensor, frost; (b) a step of causing, by a controller, a defrosting planar heating element provided in an evaporator to generate heat when frost is detected in the (a) step; and (c) a step of stopping heat generation of the defrosting planar heating element when frost is detected as being removed by the frost sensor after the (b) step.

In addition, provided is a heating control method for a planar heating element for a refrigerator, the heating control method driving the planar heating element to generate heat according to whether or not a home bar door is detected as being opened by a home bar opening/closing sensor. The heating control method may include: (a) a step of detecting, by the home bar opening/closing sensor, opening of the home bar door; (b) a step of causing, by a controller, a planar heating element for a home bar situated within a home bar support bracket to generate heat when the home bar door is detected as being opened in the (a) step; and (c) a step of stopping heat generation of the planar heating element for a home bar when the home bar door is detected as being closed by the home bar opening/closing sensor after the (b) step.

### Advantageous Effects

As described above, the planar heating element for a refrigerator according the present invention can rapidly remove frost on an evaporator with low power.

In addition, the planar heating element for a refrigerator according the present invention can rapidly prevent dew condensation on the surface of a home bar case with low power.

Furthermore, the planar heating element for a refrigerator according the present invention can rapidly remove frost in a box-shaped refrigerator, such as a kimchi refrigerator, with low power.

In addition, the planar heating element for a refrigerator according the present invention can save cost and is environmentally friendly, due to a more simplified process than that of a heating element of the related art.

Furthermore, the planar heating element for a refrigerator according the present invention can rapidly generate heat and operate with lower power per unit area, since heat is generated from a larger surface area.

In addition, the planar heating element for a refrigerator according the present invention can be disposed without restriction in location, since the planar heating element is implemented as a film.

Furthermore, the planar heating element for a refrigerator according the present invention has superior heat generation performance and higher power consumption efficiency compared to the related art, since the planar heating element provides surface heating while a related-art heating element provides local heating.

In addition, the planar heating element for a refrigerator according the present invention can control electric current to flow in opposite directions on both surfaces of a substrate by applying reverse current patterning technology, thereby efficiently blocking electromagnetic waves.

Furthermore, the planar heating element for a refrigerator according the present invention can function as a fuse by breaking a pattern by thermal expansion of a substrate when heated to a predetermined temperature or higher. Accordingly, planar heating element can be used safely.

### DESCRIPTION OF DRAWINGS

FIG. 1 is a configuration view illustrating an evaporator of a refrigerator of the related art;

FIGS. 2A, 2B, and 2C are a detailed configuration view of the evaporator illustrated in FIG. 1;

FIG. 3 is a view illustrating a refrigerator provided with a home bar;

FIGS. 4A, 4B, and 4C are a detailed configuration view of the home bar;

FIG. 5 is a view illustrating key components for controlling a planar heating element for a refrigerator according to an embodiment of the present invention;

FIG. 6 is a cross-sectional view of a defrosting planar heating element according to an embodiment of the present invention;

FIG. 7 is a plan view of the defrosting planar heating element according to an embodiment of the present invention;

FIG. 8 is another plan view of the defrosting planar heating element according to an embodiment of the present invention;

FIG. 9 is a view illustrating a pattern for generating reverse current in the defrosting planar heating element according to an embodiment of the present invention;

FIG. 10 is a cross-sectional view of the planar heating element for a home bar according to an embodiment of the present invention;

FIG. 11 is a cross-sectional view of a planar heating element for a home bar according to another embodiment of the present invention;

FIG. 12 is a plan view of the planar heating element for a home bar according to an embodiment of the present invention;

FIG. 13 is a plan view of another planar heating element for a home bar according to an embodiment of the present invention;

FIG. 14 is a view illustrating a pattern for generating reverse current according to an embodiment of the present invention;

FIG. 15 is a flowchart illustrating a method of fabricating a defrosting planar heating element according to the present invention;

FIG. 16 is a view illustrating a roll-to-roll gravure printing machine for fabricating a planar heating element according to the present invention;

FIG. 17 is a cross-sectional view illustrating the defrosting planar heating element according to another embodiment of the present invention;

FIG. 18 is a view illustrating another embodiment of the roll-to-roll gravure printing machine for fabricating a planar heating element according to the present invention;

FIG. 19 is a flowchart illustrating a control method for a defrosting planar heating element according to the present invention;

FIG. 20 is a flowchart illustrating a control method for a planar heating element for a home bar according to the present invention;

and

FIG. 21 is an example view illustrating a box-shaped refrigerator.

### MODE FOR INVENTION

Interpretation of terms or words used in this specification and claims is not limited to their conventional meanings or those defined in dictionaries, but they are to be interpreted as having meanings and concepts conforming to the technical idea of the present invention, based on the principle that the inventor can properly define the concept of terms in a way that best describe the present invention.

It will be understood that the terms “comprise”, “include”, “have”, and any variations thereof used herein are intended to cover non-exclusive inclusions unless explicitly described to the contrary. In addition, the terms, such as “unit”, “device”, “module”, and “apparatus”, used herein are intended to designate a unit processing at least one function or operation and may be realized by hardware, software, or a combination thereof.

It will be understood that the term “and/or” used herein include all combinations or any of a plurality of listed items. For example, an expression “a first item, a second item, and/or a third item” shall indicate not only a first item, a second item, or a third item, but also any of combinations derived from two or more of the first item, the second item, and the third item.

Reference numerals (e.g. a, b, c, and may be used herein to indicate steps. It should be understood, however, that such reference numerals are merely used for the sake of brevity but do not limit the order of the steps. The order of the steps may vary from the order rendered in the specification, unless explicitly described to the contrary in the context. That is, the steps may take place in the same order as rendered in the specification, may be performed substantially simultaneously, or may be performed in a reverse order from the order rendered in the specification.

The present study has been conducted under the control of PARU Co., Ltd., in WC300 R&D project supported by the Korea Institute for Advancement of Technology (KIAT) under the Ministry of Trade, Industry and Energy of the Republic of Korea. The title of the study project is the development of anti-freezing equipment for a polar offshore plant to which a silver nano film heater is applied (project number: S2460499).

Hereinafter, an exemplary embodiment of the present invention will be described with reference to the accompanying drawings.

First, a position in which a defrosting planar heating element according to the present invention is disposed will be described with reference to a configuration of a refrigerator having a defrost function of the related art.

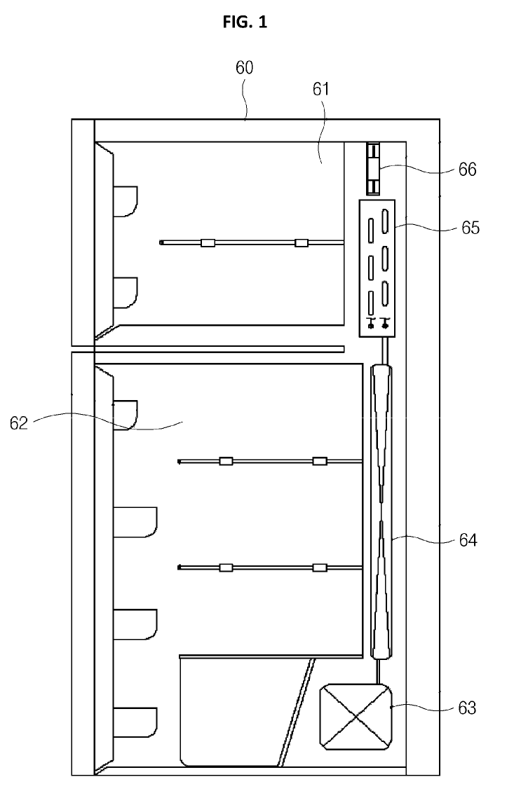

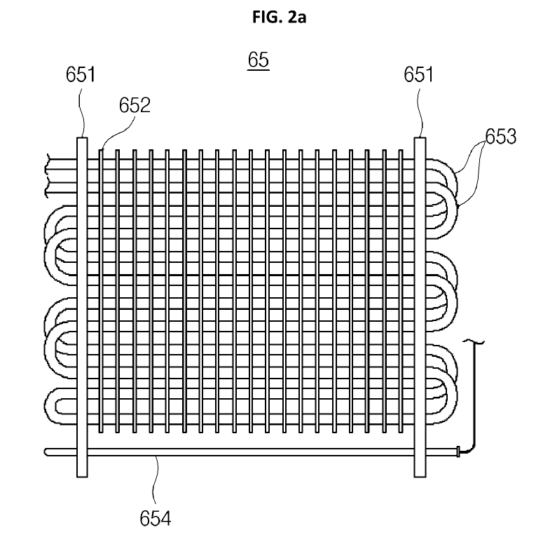

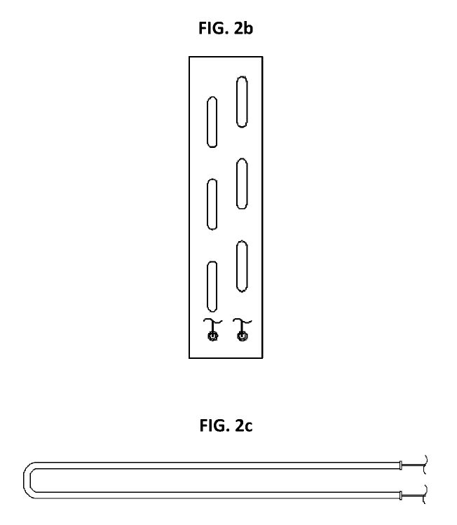

FIG. 1 is a configuration view illustrating an evaporator of a refrigerator of the related art, and FIG. 2 is a detailed configuration view of the evaporator illustrated in FIG. 1.

Referring to the drawings, a freezing chamber 61 is provided in an upper section of a body 60, and a refrigerating chamber 62 is provided below the freezing chamber 61. A compressor 63 compresses gas taken from an evaporator 65 to a high pressure and transports the compressed gas to a condenser 64. The gas, compressed in the compressor 63, is transformed into liquid while passing through the condenser 64. The liquid from the condenser is taken into the evaporator 65, where the liquid is transformed into gas by absorbing heat from the surroundings. The gas is taken into the compressor 63 again. In such a circulation cycle, latent heat is recovered from the surroundings through adiabatic compression and expansion.

Here, when the evaporator 65 absorbs heat from the surroundings due to transformation from liquid to gas, frost is formed on the evaporator, thereby degrading the performance of the evaporator.

In this regard, with reference to FIG. 2, the evaporator 65 is provided with two layers of refrigerant pipes 653, through which liquid refrigerant flows, and a plurality of heat dissipation fins 652 disposed in an intended direction. This configuration is intended to increase the surface area to rapidly recover latent heat from the surroundings. The refrigerant pipes 653 are fixed using fixing devices 651.

In order to remove such frost, a defrost device 654 is disposed on the bottom of the evaporator 65, i.e. below the refrigerant pipes 653, through which liquid refrigerant flows, as a related-art configuration able to remove frost.

The defrost device 654 is provided as a pipe-shaped heater. The defrost device 654 is disposed below the evaporator to operate for a previously-input period, under the control of a controller, in order to remove thick frost formed on the surface of the evaporator.

The present invention is characterized by providing a defrosting planar heating element able to rapidly and efficiently remove frost with low power, instead of the pipe-shaped heater of the related art as described above.

Although planar heating elements may be provided in a plurality of positions of a refrigerator according to the present invention, planar heating elements for an evaporator and a home bar will be described for the sake of brevity.

That is, it should be understood that configurations of the planar heating elements for an evaporator and a home bar and fabrication method thereof may be used in other portions of a refrigerator, such as a water pipe heater, an ice-making tray heater, a drain heater, a mullion heater (i.e. a warm heater), a case heater, a frame heater of a home bar, a door heater of a home bar, a door heater, an ice chute heater, an ice chute cover heater, a housing rear side heater, a water tray heater, a cold air passage heater, a cold air duct heater, a cold air return duct heater, a heat exchanger connecting member heater, a cam holder-compatible heater, a control box-compatible heater, a case heater, and a barrier heater.

A defrosting planar heating element 100 according to the present invention is located on the top surface or the bottom surface of the evaporator 65 to operate such that surface heating is performed at a predetermined temperature, thereby defrosting the evaporator 65.

Hereinafter, the defrosting planar heating element 100 according to the present invention will be described in detail.

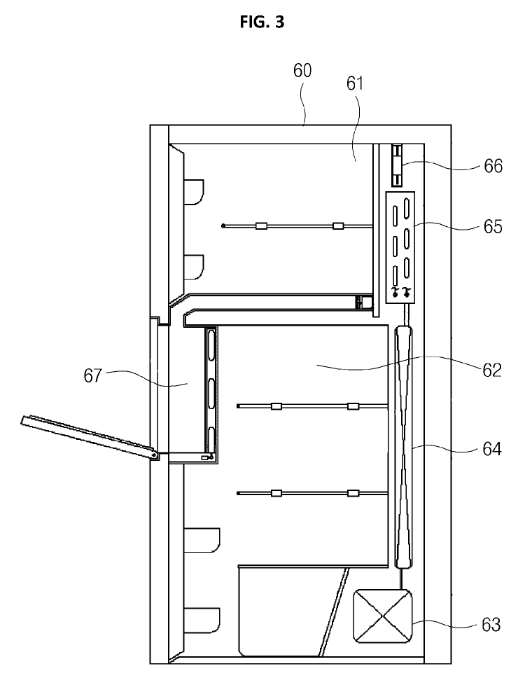

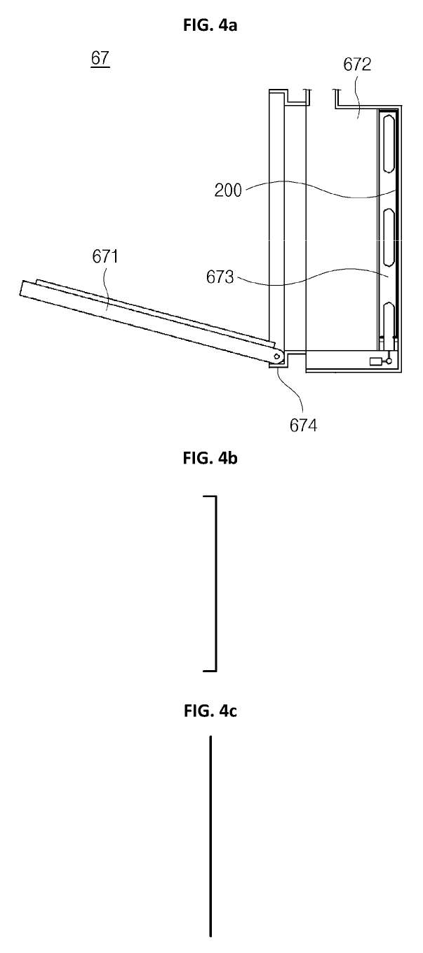

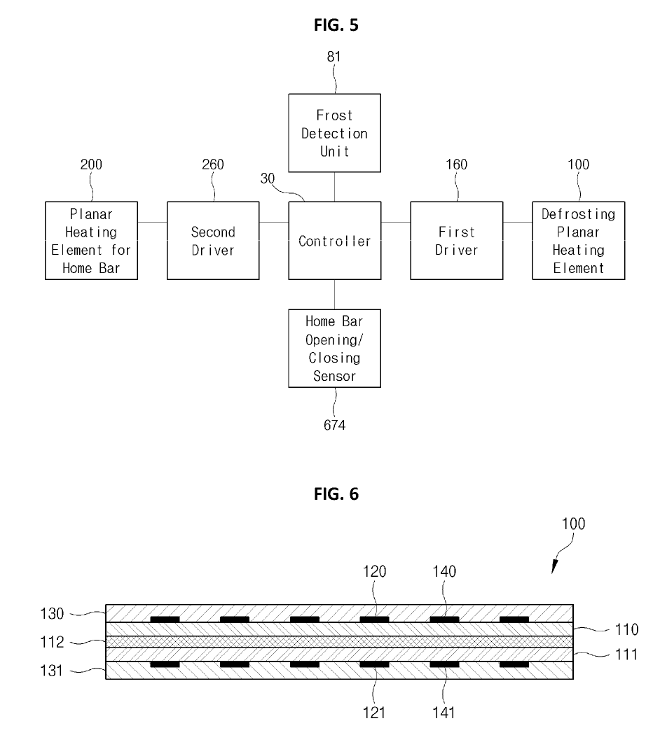

In addition, an embodiment of the present invention is also characterized by providing a planar heating element for a home bar, the planar heating element being able to prevent dew condensation when the home bar is used, with reference to FIG. 3, which illustrates a refrigerator provided with a home bar, and FIGS. 4a to 4c, which illustrates a detailed configuration of the home bar.

Referring to the drawings, a home bar 67 is typically provided in a front portion of the refrigerating chamber 62, such that foods can be taken out or into the refrigerating chamber 62 without opening of the door of the refrigerating chamber 62.

The home bar 67 includes a home bar door 671, a home bar opening/closing sensor 674 detecting whether the home bar door 671 is opened or closed, a storage space 672 holding foods therein and having an open area, through which cold air enters, and a home bar case 673 disposed on a rear side of the storage space 672 to support the home bar.

In addition, a gasket may be provided between the home bar case 673 and the home bar door 671 to prevent cold air from leaking from the inside to the outside.

When the home bar 67 is frequently used, dew may be condensed on the surface of the home bar case 673. The planar heating element according to the present invention is disposed inside or outside of the home bar case 673 to heat the inside of the home bar case 673 at a predetermined temperature, thereby preventing dew condensation.

Referring to FIGS. 4a to 4c, a planar heating element 200 for a home bar is situated inside of the home bar case 673 and is configured to surround a portion of a top surface, a portion of a bottom surface, and a rear surface of the home bar case 673.

The planar heating element 200 for a home bar according to the present invention includes a substrate implemented as a film and a pattern printed on the substrate by printed electronics technology. Accordingly, the planar heating element 200 is configured as a planar structure, as in FIG. 4c, and top and bottom portions thereof are bent in an assembly, as in FIG. 4b. As FIG. 4a, the planar heating element 200 is fixed such that the bent portions are positioned on the top and bottom surfaces of the home bar case 173.

Hereinafter, the planar heating element according to the present invention will be described with reference to the drawings.

FIG. 5 is a view illustrating key components for controlling the planar heating element for a refrigerator according to an embodiment of the present invention. As illustrated in FIG. 5, a controller 30 is provided to drive the planar heating element according to the present invention. The controller 30 includes a frost detection unit 81 detecting a deposit of frost on the evaporator 65 and the home bar opening/closing sensor 674 detecting whether the door of the home bar 67 is opened or closed. When frost is detected by the frost detection unit 81, the controller 30 operates a first driver 160 to apply electric power to the defrosting planar heating element 100, thereby removing frost on the evaporator. When the door of the home bar is detected as being opened by the home bar opening/closing sensor 674, the controller 30 operates a second driver 260 to apply electric power to the planar heating element 200 for a home bar, thereby preventing dew condensation.

Although it has been described that the frost detection unit 81 and the home bar opening/closing sensor 674 are used to efficiently remove frost and prevent dew condensation according to an embodiment of the present invention, the frost detection unit 81 and the home bar opening/closing sensor 674 may be selectively used. The defrosting planar heating element 100 or the planar heating element 200 for a home bar may be periodically controlled without the detection unit or the sensor, such that heat is generated for specific periods of time, which are set based on frosting or dew condensation during the use of the refrigerator.

The defrosting planar heating element 100 according to the present invention is located on the top or the bottom of the evaporator 65 and operates such that the surface thereof is heated at a predetermined temperature. Since the defrosting planar heating element 100 generates heat from both surfaces of the substrate, frost can be more efficiently removed.

Referring to a cross-sectional view in FIG. 6, which illustrates the defrosting planar heating element according to an embodiment of the present invention, the planar heating element 100 according to the present invention is fabricated by printing a pattern 140 of a silver heating line on a first substrate 110 using conductive ink, printing a pattern 141 of a silver heating line on a second substrate 111 using conductive ink, and bonding the substrates to each other using an adhesive layer 112. Here, power terminals 120 and 121 are provided to supply electric power to the patterns, respectively.

Carbon layers 130 and 131 may be layered on the top surfaces of the patterns 140 and 141, respectively.

The present invention is characterized in that the same silver heating lines are fabricated on different substrates and configured to apply flows of electric current in opposite directions to cancel magnetic waves. It is accordingly possible to obtain the same magnetic wave shielding effect using the configuration of patterns, instead of being provided with an additional component.

In this regard, the patterns are provided on the substrates in an alternating manner.

Since the present invention is intended to effectively shield magnetic waves by applying printed electronics technology and reverse current print patterning technology, both substrates are printed with the same patterns, and when the substrates are bonded together, flows of electric current are applied in opposite directions to cancel magnetic waves.

Accordingly, electrodes are fabricated in the same positions and the same patterns are provided, since the patterns must conform to each other when the substrates are bonded together.

In addition, the present invention has been described that the patterns are printed on different substrates before the substrates are bonded together, for the sake of brevity. It should be understood, however, that the present invention is not limited thereto and the patterns may be printed on both surfaces of a single substrate.

That is, referring to a cross-sectional view in FIG. 17, which illustrates a defrosting planar heating element according to another embodiment of the present invention, a first pattern 140 of a silver heating line may be printed on one surface of a first substrate 110 using conductive ink, a second pattern 141 of a silver heating line may be printed on the other surface of the first substrate 110 using conductive ink, and then carbon layers 130 and 131 may be layered on the top surfaces of the first pattern 140 and the second pattern 141, respectively. Here, the power terminals 120 and 121 may be provided to supply electric power to the silver heating lines, respectively.

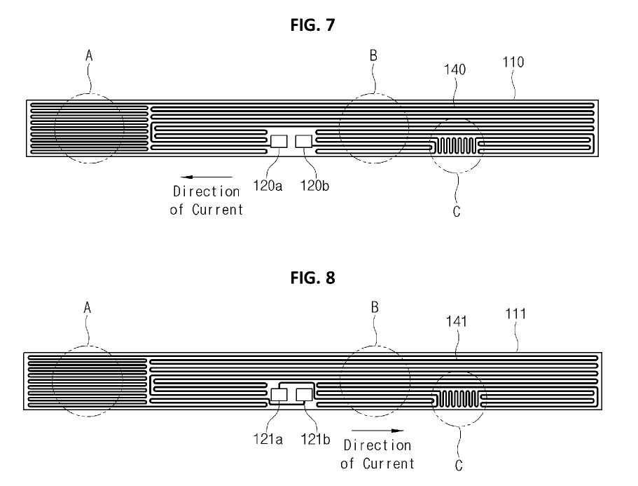

First, referring to a plan view in FIG. 7, which illustrates the defrosting planar heating element according to an embodiment of the present invention, the first substrate 110 is cut in a planar shape similar to that of the cross-sectional area of the bottom or top portion of the evaporator, such that the first substrate 110 is provided on the top or bottom of the evaporator 15. The first substrate 110 can generate heat from the surface thereof to the top or bottom portion of the evaporator in order to remove frost.

In the drawing, the first substrate is illustrated as being cut in a rectangular shape.

A positive (+) electrode 120a and a negative (−) electrode 120b are sequentially disposed on one surface of the first substrate 110. According to the present invention, the pattern is completed by repeatedly extending away from a location of the positive (+) electrode 120a and extending toward the electrode at a predetermined distance from the portion extending away from the positive (+) electrode 120a, so as to be connected to the positive (+) electrode 120a and one end of the negative (−) electrode 120b.

That is, the pattern connected to the positive (+) electrode 120a alternately and repeatedly extends to one end of the substrate 110 in the left direction (in the drawing) and extends in the right direction at a predetermined upward distance from the portion extending in the left direction before being connected to the negative (−) electrode 120b, thereby allowing electric current to flow therethrough.

Consequently, the pattern according to the present invention provides a closed circuit in which repeated sections are provided, and the electrode terminals, i.e. the positive (+) electrode 120a and the negative (−) electrode 120b, are sequentially disposed. The pattern having this configuration enables surface heating.

That is, the positive (+) electrode 120a and the negative (−) electrode 120b are sequentially disposed. The pattern is formed along the shape of the substrate to provide a closed circuit in which the extending portions of the pattern have predetermined distances from each other. The closed circuit of the pattern provides surface heating in response to electric current flowing therethrough.

Referring to FIG. 7, it can be appreciated that areas designated with reference numerals “A”, “B”, and “C” are discriminated from each other.

This can be used in the case in which the density of the pattern is changed or the pattern is shaped to be shorter or longer as required in order to obtain different heating temperatures.

That is, the density or shape of the pattern may be varied when different heating temperatures are required, depending on the structure of the evaporator.

In addition, since the present invention is characterized by effectively shielding magnetic waves by applying printed electronics technology and reverse current print patterning technology, the same pattern is fabricated on the other substrate, such that the patterns overlap and conform to each other when the substrates are bonded together. Here, flows of current are applied in opposite directions, so that magnetic waves can be canceled.

Accordingly, the patterns must be fabricated the same, since the patterns conform to each other when the substrates are bonded together. It is convenient in terms of fabrication to fabricate the electrodes in the same positions if possible.

Since the planar heating element is fabricated by forming the pattern on the film substrate using printing technology, the fabrication of the electrodes is an important factor to determine the overall thickness of the planar heating element. Accordingly, as few electrodes as possible must be used.

Specifically, a plan view in FIG. 8, which illustrates the defrosting planar heating element according to an embodiment of the present invention, will be referred to.

A positive (+) electrode 121a and a negative (−) electrode 121b are sequentially disposed on one surface of the second substrate 111, in positions corresponding to the positive (+) electrode 120a and the negative (−) electrode 120b of the first substrate 110.

In this regard, the electrodes are provided in the same positions, and the patterns connected to the electrode terminals are connected in opposite directions such that the patterns conform to each other.

Referring to the drawing, it can be appreciated that the pattern connected to the positive (+) electrode 121a and the pattern connected to the negative (−) electrode 121b are in the opposite directions.

There is no reason to limit the positions of the electrodes, since such matching of the electrodes is intended to allow the terminals to be easily connected by two-hole riveting when the substrates are bonded together.

That is, the present invention is characterized in that, since the electrodes fabricated on both surfaces of a single substrate or on different substrates are located in equal positions in a top-bottom (or vertical) direction and have the same polarity, the upper and lower electrodes can be simply connected by two-hole riveting or any other direct electrode-connecting method.

Accordingly, when the patterns are located in the same positions, the electrodes may be fabricated in different positions as required.

Since the patterns according to the present invention are required to be located on the bottom or top of the evaporator, the patterns must be elongated along the rear portion of the refrigerator in consideration of the structure. Thus, the electrodes are located in a substantially central portion of the substrate.

In addition, the pattern is completed by repeatedly extending away from a location of the negative (−) electrode 120b and extending toward the electrode at a predetermined distance from the portion extending away from the negative (−) electrode 120b, so as to be connected to the negative (−) electrode 120b and one end of the positive (+) electrode 120a.

That is, the pattern connected to the negative (−) electrode 120b alternately and repeatedly extends to one end of the substrate 110 in the left direction (in the drawing) and extends in the right direction at a predetermined upward distance from the portion extending in the left direction before being connected to the positive (+) electrode 120a, thereby allowing electric current to flow therethrough.

Referring to the plan views of FIGS. 7 and 8, the electrodes are provided in the same central positions but portions of the patterns connected to the electrodes are changed. Thus, flows of electric current are in laterally opposite directions in the substrates.

Accordingly, when the patterns are provided in the same positions, the electrodes may be fabricated in different positions as required.

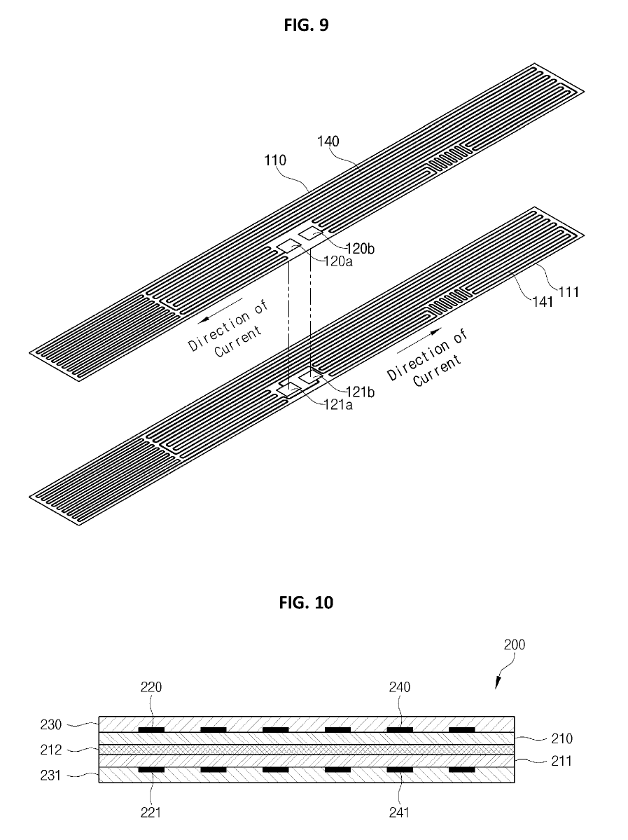

FIG. 9 is a view illustrating a pattern for generating reverse current according to an embodiment of the present invention, and illustrating a current flow in a case in which the substrates are bonded together.

Referring to the drawing, when the first substrate 110 and the second substrate 111 are bonded to each other, the patterns overlap with respect to the adhesive layer 112, as in a mirror.

Accordingly, when electric current is caused to flow in the patterns in opposite directions in order to apply reverse current print patterning technology to the overlapping patterns, magnetic waves are canceled.

As described above, according to the present invention, different substrates are printed with the same patterns and are bonded to each other in order to effectively shield magnetic waves by applying printed electronics technology and reverse current print patterning technology.

In addition, since reverse current patterning technology must be used by fabricating the electrodes on the substrates as described above, the terminals of the electrodes on the substrates are connected by two-hole riveting so that the characteristics of the films can be complemented and reliability can be obtained when electric power is applied through the electrodes.

The defrosting planar heating element can also be used as a box-shaped planar heating element.

That is, referring to FIG. 21, which illustrates a box-shaped refrigerator, a case in which the planar heating element is used in a box-shaped refrigerator, such as a kimchi refrigerator, is taken by way of example.

Referring to the drawing, a box-shaped refrigerator 44 is configured such that a container holding foods to be refrigerated or frozen is received within a box-shaped case 40 through an open area provided in one portion of the box-shaped case 40.

A sliding tray 47 provided within the case 40 allows the container to easily slide into the case 40.

The box-shaped refrigerator is provided with an evaporator 42 surrounding a portion of a left side, a portion of a right side, and a top surface. In this case, frost may be formed on the evaporator 42.

Thus, the defrosting planar heating element according to the present invention may be provided on one portion of the evaporator. When it is determined that frost is formed, the planar heating element may be operated to generate heat, thereby removing frost.

Since a process of fabricating the defrosting planar heating element is the same as a process of fabricating the planar heating element for a home bar, the configuration of the planar heating element for a home bar will be described before description of the fabrication process.

Hereinafter, the planar heating element for a home bar will be described with reference to the drawings.

FIG. 10 is a cross-sectional view of the defrosting planar heating element for a home bar according to an embodiment of the present invention. In the planar heating element 200 for a home bar according to the present invention, as in the defrosting planar heating element 100, a third pattern 240 of a silver heating line is printed on a third substrate 210 using conductive ink, a fourth pattern 241 of a silver heating line is printed on a fourth substrate 211 using conductive ink, and the substrates are bonded to each other using an adhesive layer 212. Here, power terminals 220 and 221 are provided to supply electric power to the patterns, respectively.

This configuration is the same as the configuration illustrated in the cross-sectional view of the defrosting planar heating element, except that the positions of the electrodes are changed as required. Accordingly, repeated descriptions thereof will be omitted.

Carbon layers 230 and 231 may be layered on the top surfaces of the patterns 240 and 241, respectively.

In the planar heating element for a home bar according to the present invention, the same silver heating lines are fabricated on different substrates and flows of electric current are applied in opposite directions to cancel magnetic waves, so that the same effect as magnetic wave shielding can be obtained.

In this regard, the patterns are provided on the substrates in an alternating manner.

Since the present invention is intended to effectively shield magnetic waves by applying printed electronics technology and reverse current print patterning technology, both substrates are printed with the same patterns, and when the substrates are bonded together, flows of electric current are applied in opposite directions to cancel magnetic waves.

Accordingly, the electrodes are fabricated in the same positions and the same patterns are provided, since the patterns must conform to each other when the substrates are bonded together.

In addition, the present invention has been described that the patterns are printed on different substrates before the substrates are bonded together, for the sake of brevity. It should be understood, however, that the present invention is not limited thereto and the patterns may be printed on both surfaces of a single substrate.

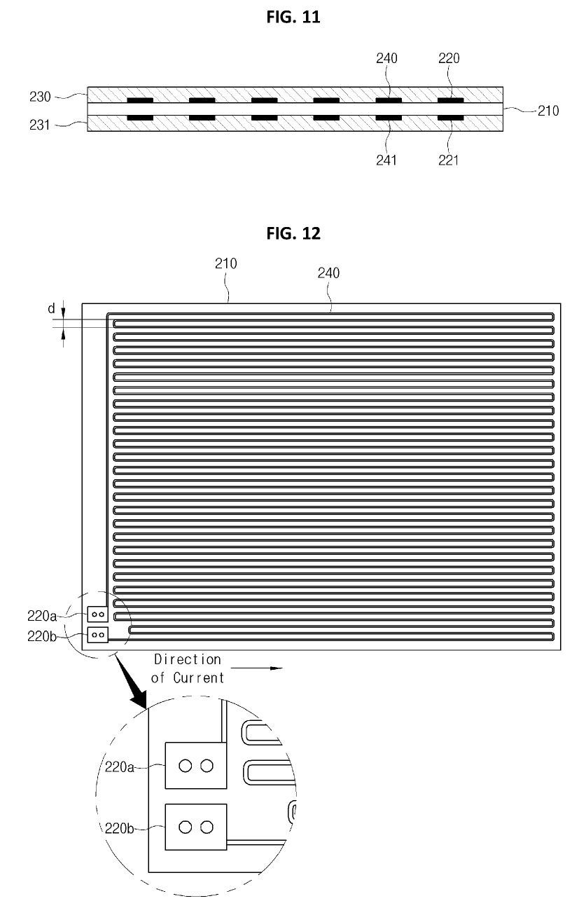

That is, referring to a cross-sectional view in FIG. 11, which illustrates a defrosting planar heating element according to another embodiment of the present invention, a third pattern 240 of a silver heating line may be printed on one surface of a third substrate 210 using conductive ink, a fourth pattern 241 of a silver heating line may be printed on the other surface of the third substrate 210 using conductive ink, and then carbon layers 230 and 231 may be layered on the top surfaces of the third pattern 240 and the fourth pattern 241, respectively. Here, the power terminals 220 and 221 may be provided to supply electric power to the silver heating lines, respectively.

Referring to a plan view in FIG. 12, which illustrates the planar heating element for a home bar according to an embodiment of the present invention, the first substrate 210 is cut in a planar shape conforming to the top, bottom, and rear surfaces of the home bar, such that the first substrate 210 can disposed on the top, bottom, and rear surfaces of the home bar to generate heat from the surface thereof.

In the drawing, the first substrate is illustrated as being cut in a rectangular shape.

First, a positive (+) electrode 220a and a negative (−) electrode 220b are sequentially disposed on one surface of the substrate.

Since the planar heating element for a home bar according to the present invention is located on portions of the top and bottom surfaces and on the rear surface of the home bar to generate heat, the electrodes may be preferably disposed adjacent to one edge of the substrate to facilitate connection of the power terminals.

In the drawing, the electrodes are provided on the bottom left end of the substrate.

The pattern according to the present invention is completed by repeatedly extending away from a location of the negative (−) electrode 220b and extending toward the electrode at a predetermined distance from the portion extending away from the negative (−) electrode 220b, so as to be connected to the negative (−) electrode 220b and one end of the positive (+) electrode 220a.

That is, the pattern connected to the negative (−) electrode 220b alternately and repeatedly extends from the left to the right (in the drawing), extends from the right to the left at a predetermined distance d from the portion extending from the left to the right (for example, in the bottom to top direction in the drawing), and extends from the left to the right at the predetermined distance d from the portion extending from the right to the left in the bottom to top direction in the drawing before being connected to the positive (+) electrode 220a, thereby allowing electric current to flow therethrough.

That is, the pattern of the planar heating element for a home bar is formed along the shape of the substrate to provide a closed circuit in which the positive (+) electrode 220a and the negative (−) electrode 220b are sequentially disposed and turns of the pattern have predetermined distances from each other. The closed circuit of the pattern provides surface heating in response to electric current flowing therethrough.

Since the present invention is characterized by effectively shielding magnetic waves by applying printed electronics technology and reverse current print patterning technology, the same pattern is fabricated on the other substrate, such that the patterns overlap and conform to each other when the substrates are bonded together. Here, flows of current are applied in opposite directions, so that magnetic waves can be canceled.

Accordingly, the patterns must be fabricated the same, since the patterns conform to each other when the substrates are bonded together. It is convenient in terms of fabrication to fabricate the electrodes in the same positions if possible.

Since the planar heating element is fabricated by forming the pattern on the film substrate using printing technology, the fabrication of the electrodes is an important factor to determine the overall thickness of the planar heating element. Accordingly, as few electrodes as possible must be used.

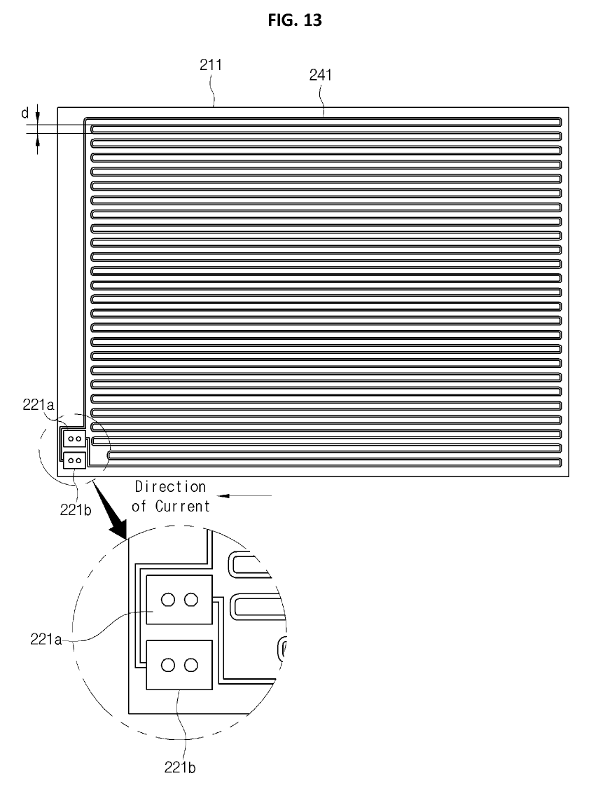

Specifically, a plan view in FIG. 13, which illustrates another defrosting planar heating element, will be referred to.

A positive (+) electrode 221a and a negative (−) electrode 221b are sequentially disposed on one surface of the second substrate 211, in positions corresponding to the positive (+) electrode 120b and the negative (−) electrode 120a of the first substrate 210.

That is, the electrodes of the substrates are provided in the same positions, and the patterns connected to the electrode terminals are connected in opposite directions such that the patterns conform to each other.

There is no reason to limit the positions of the electrodes, since such matching of the electrodes is intended to allow the terminals to be easily connected by two-hole riveting when the substrates are bonded together.

Accordingly, when the patterns are located in the same positions, the electrodes may be fabricated in different positions as required.

In addition, the pattern is completed by repeatedly extending away from a location of the positive (+) electrode 221a and extending toward the electrode at a predetermined distance from the portion extending away from the positive (+) electrode 221a, so as to be connected to the positive (+) electrode 221a and one end of the negative (−) electrode 221b.

That is, the pattern connected to the positive (+) electrode 221a alternately and repeatedly extends from the left to the right (in the drawing), extends from the right to the left at a predetermined distance d from the portion extending from the left to the right (for example, in the bottom to top direction in the drawing), and extends from the left to the right at the predetermined distance d from the portion extending from the right to the left in the bottom to top direction in the drawing before being connected to the negative (−) electrode 221b, thereby allowing electric current to flow therethrough.

Referring to the plan views of FIGS. 12 and 13, the electrodes are provided in the same bottom left ends of the drawings but portions of the patterns connected to the electrodes are changed. Thus, electric current flows in opposite directions in the upper and lower substrates.

Accordingly, when the patterns are provided in the same positions, the electrodes may be fabricated in different positions as required.

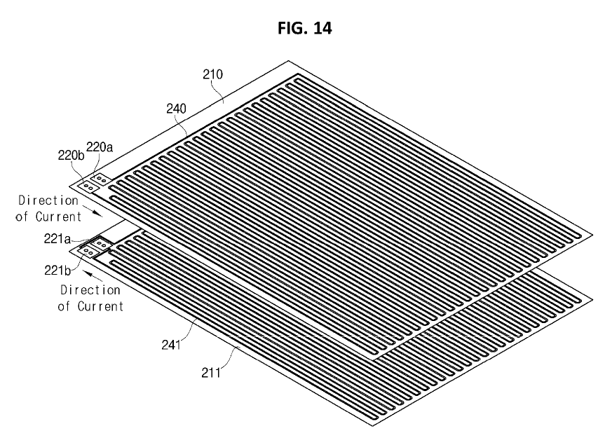

FIG. 14 is a view illustrating a pattern for generating reverse current according to an embodiment of the present invention, and illustrating a current flow in a case in which the substrates are bonded together.

Referring to the drawing, when the first substrate 210 and the second substrate 211 are bonded to each other, the patterns overlap with respect to the adhesive layer 212, as in a mirror.

Accordingly, when electric current is caused to flow in the patterns in opposite directions in order to apply reverse current print patterning technology to the overlapping patterns, magnetic waves are canceled.

As described above, in order to effectively block magnetic waves using printed electronics technology and reverse current print patterning technology, respective substrates according to the present invention are printed with the same patterns and are bonded to each other to effectively block magnetic waves.

Hereinafter, a fabrication process of the defrosting planar heating element or the planar heating element for a home bar will be described.

In addition, the configuration of the defrosting planar heating element will be mainly described for the sake of brevity.

The substrates 110 and 111 of the defrosting planar heating element are implemented as a polyethylene terephthalate (PET) film or a polyimide (PI) film, which is subjected to a printing process.

Here, PET is thermoplastic, while PI is thermoset. According to the present invention, PET or PI may be selectively used as required.

That is, PET can be used in a low-temperature application, due to the thermoplasticity thereof, and PI can be used in a high-temperature application. Accordingly, the substrate is determined to be a PET substrate or a PI substrate as required, and coating is performed to the substrate, which is then used.

In addition, according to the present invention, the substrate may be made of polyvinyl butyral (PVB), ethylene-vinyl acetate (EVA), or thermoplastic polyurethane (TPU).

According to the present invention, when voltages are applied to the heating lines 140 and 141, printed on the substrates 110 and 111 with conductive ink, through the electrodes, current is supplied to the heating element so that heat is uniformly generated from the surface of the heating element.

Preferably, different amounts of ink and different fabrication methods must be developed depending on situations, so that heat can be generated at a high temperature as intended.

Such conductive ink may be implemented as one selected from among, but not limited to, a silver paste, a carbon paste, carbon nanotube, and silver nano ink.

When the silver heating lines are used, silver nano gel is produced, and the heating line is printed on the first substrate 110 using conductive silver ink including the silver nano gel.

Conductive fabric may be layered on top of the carbon layers 130 and 131, respectively, as required. Insulation layers produced in this manner prevent the heating lines 140 and 141 from being damaged while providing an electromagnetic wave shielding effect. The conductive fabric is implemented as a flexible material.

Although a typical heat protection film mainly serves to dissipate heat, the conductive fabric according to the present invention is intended to have an electromagnetic wave shielding function as a complementary function.

That is, the conductive fabric is intended to provide electromagnetic wave shielding in a complementary manner although electromagnetic wave shielding is provided by reverse current print patterning technology according to the present invention.

In addition, a permalloy layer (not shown) may further be layered on top of the conductive fabric in order to more effectively block magnetic fields.

Permalloy is an alloy, the composition of which includes about 80% nickel and 20% iron. Permalloy is an excellent magnetic material having very high magnetic permeability and small magnetic hysteresis. Permalloy can be easily machined to a variety of complicated shapes, due to excellent machinability thereof.

In addition, when the walls are made of permalloy, external magnetic waves are absorbed by the walls without entering the inside. In contrast, when a point at which a magnetic field is generated is surrounded by permalloy walls, the magnetic field cannot exit through the walls.

As described above, the electromagnetic wave shielding heating film having the above-described configuration according to the present invention is completed by heat drying. A suitable heat drying temperature ranges from 100 to 200° C., and a suitable heat drying time ranges from 1 to 60 minutes.

In addition, the present invention is also characterized in that the patterns, i.e. the heating lines, are opened by thermal expansion of the substrate, so that the substrate and the heating lines function as fuses at predetermined temperatures.

That is, the present invention may be configured such that the heating lines are broken in response to expansion of the substrate heated to a predetermined temperature, thereby preventing fire or the like.

In this regard, it is necessary to adjust points in time, at which the lines are broken, according to a plurality of temperatures, since the film has different deflection temperatures depending on the type of the film, i.e. the type of the substrate.

Accordingly, it is necessary to identify a degree of random deflection under a predetermined amount of load, with reference to the heat deflection temperature (HDT) of a plastic resin of the film used as the substrate according to the present invention.

The heat deflection temperature means a temperature at which a test specimen starts to deflect in a process of fixing the specimen using a holder of a measuring instrument, immersing the specimen in silicone oil by applying prescribed load to the specimen, and then heating the oil at a predetermined rate until the specimen deflects 0.254 mm.

Table 1 illustrates heat deflection temperatures of plastic resins (source: HEAT DEFLECTION OF UV CURING/published by UV SMT)

TABLE 1

| Resin name | Heat deflection temperature (° C.) |
|---|---|
| PE | 40 to 85 |
| PP | 100 to 110 |
| PS | 60 to 95 |
| Acrylic resin | 70 to 90 |
| A.B.S resin | 70 to 105 |
| PA | 130 to 180 |
| PVC | 70 to 80 |
| ABS | 75 to 87 |
| PET | 140 to 240 |
| PC | 100 to 130 |
| PI | 270 to 280 |
| PMMA (acrylic) | 90 o 110 |

Referring to Table 1, heat deflection temperatures according to materials of the substrate can be determined. When a material is suitably selected depending on the purpose of use, the pattern of the heating line may be broken due to heat deflection of the overheated substrate. In this manner, the pattern can function as a fuse.

In this case, the heating line may be easily broken when the direction of heat deflection of the substrate is set to be the same as the direction of the pattern.

Hereinafter, a method of fabricating the planar heating element for a refrigerator according to an embodiment of the present invention will be described with reference to the drawings.

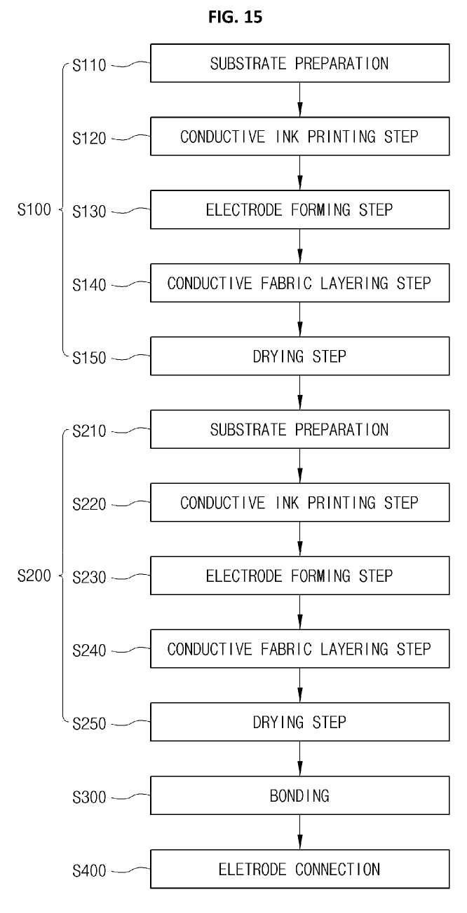

FIG. 15 is a flowchart illustrating a method of fabricating a defrosting planar heating element according to the present invention. As illustrated in FIG. 15, the planar heating element according to the present invention includes step S100 of fabricating a heating sheet on one surface of a first substrate and step S200 of fabricating a heating sheet on one surface of a second substrate.

First, step S100 of fabricating the heating sheet on one surface of the first substrate may include step S110 of preparing the first substrate 110, conductive ink printing step S120 of printing a first pattern 140 of a silver heating line on one surface of the prepared first substrate 110 using conductive ink, electrode fabrication step S120, step S140 of layering a heat protection film of conductive fabric above the first pattern 140 after the conductive ink printing step S130, and drying step S150.

In addition, before the conductive ink printing step S120 is performed, a step of manufacturing conductive ink to be used in printing may be performed.

For example, before the manufacture of the conductive silver ink, silver nano gel is manufactured in order to manufacture the conductive silver ink including the silver nano gel.

First, in the silver nano gel, a silver ion aqueous solution is manufactured by dissolving 0.3 g AgNO₃ into 10 ml of distilled water.

That is, 0.3 g silver oxide (AgNO₃), produced by mixing nano-sized particles of silver (Ag) with nitrate (NO₃), is dissolved into 10 ml of distilled water, thereby manufacturing a silver ion aqueous solution.

Although the silver ion aqueous solution has been described as being manufactured by dissolving silver oxide into distilled water according to the present invention, the silver ion aqueous solution may be manufactured by dissolving a silver oxide (CH₃COOAg) aqueous solution comprised of nano-sized particles of silver (Ag) and acetic acid (CH₃COO) into distilled water.

Afterwards, one or more polymeric binders selected from among polymer pyrrolidone, polymeric urethane, and amide group polymer are added to the manufactured silver ion aqueous solution, and a dispersant is added and stirred so that the polymeric binders are uniformly dispersed. 0.5 g of 10% hydrazine (N₂H₄) solution is slowly added to the dispersed solution. After additional stirring for three (3) hours, a dark green solution is manufactured.

Subsequently, 20 ml of acetone is added, followed by stirring for one (1) minute. Silver precipitate is collected by separation performed for 30 minutes at 6,000 rpm using a centrifuge. Then, 0.1 g diethanol 2,2-azobis is added to the silver precipitate, thereby manufacturing 0.2 g silver nano gel.

When the silver nano gel is manufactured as above, conductive silver ink including the silver nano gel is manufactured. Here, a conductive paste is dispersed in a solvent at room temperature, so that epoxy, silver particles, and a curing agent are added and stirred, so that conductive ink including the silver nano gel is finally manufactured.

First, it will be described that roll-to-roll gravure printing is used in the present invention, although the planar heating element according to the present invention may be printed by one selected from among, but not limited to, roll-to-roll gravure printing, rotary screen printing, and gravure offset printing.

First, the first substrate 110 comprised of PET or PI S110 is prepared (S110).

The first pattern 140 of the silver heating line is formed on the prepared first substrate 110 using conductive ink (S120).

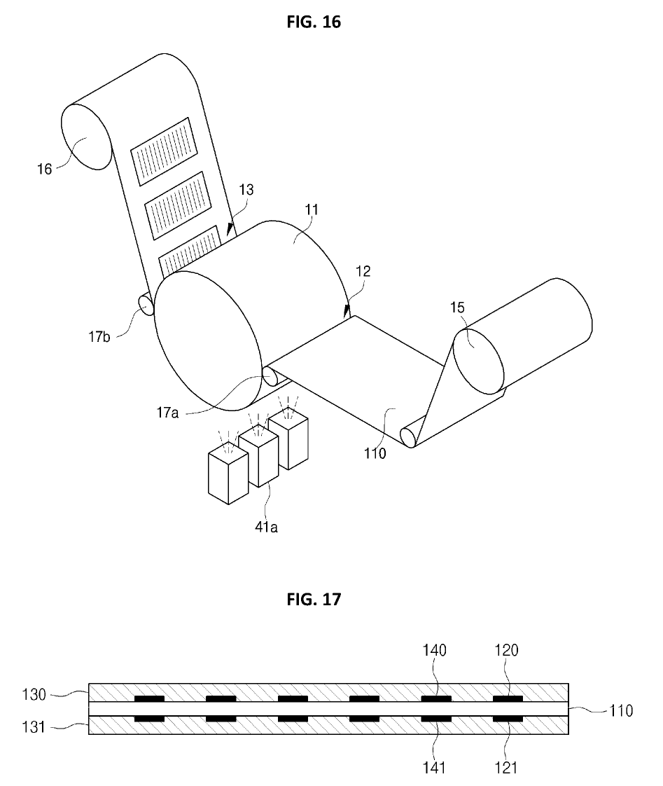

FIG. 16 is a view illustrating a roll-to-roll gravure printing machine for fabricating a planar heating element according to the present invention. An apparatus for fabricating a planar heating element according to the present invention includes a plate roller 11 provided with an embossed mold, one or more guide rollers 17a and 17b guiding the first substrate (i.e. film or web) 110, a feed roller 15 feeding the substrate, and a winding roller 16, around which the first substrate 110 having a pattern printed on one surface thereof is wound.

First, the embossed printing mold is fabricated and is connected to the plate roller 11.

The printing mold is completed by coating a surface of a substrate with a photosensitive agent and fabricating an embossed pattern through ultraviolet (UV) exposure, development, metallization, electroforming, and a cleaning step of removing residual ink from the surface.

More specifically, to fabricate the printing mold, a photosensitive layer is formed on the surface of the prepared substrate by coating the substrate with the photosensitive agent in order to fabricate the pattern on the substrate by photolithography.

Here, photoresist coating may be performed using one method selected from among, but not limited to, spin coating, slit and spin coating, slit coating and capillary coating.

In addition, the photosensitive agent coating step is an important process step in which the depth of the pattern is determined by the thickness of coating.

When the substrate is coated with the photosensitive agent, the embossed pattern is fabricated through the UV exposure, development, metallization, and electroforming, as well as the cleaning step.

In the fabrication of the pattern, the pattern is fabricated by exposing the coating layer to UV radiation through a mask and dissolving uncured portions in the development.

Here, the radiation (or exposure) applied to the photoresist is performed by selecting a suitable level of intensity and a suitable wavelength range, since the radiation is required to be suitable to the sensitivity of the photoresist. For example, the photoresist may be exposed to a wavelength ranging from 200 to 300 nm, at a level of intensity of 1 to 100 mW/cm², for 2 to 15 seconds.

When the photoresist selectively exposed via the photoresist is developed, portions are dissolved due to a solubility difference, thereby forming the pattern. A developing solution used in this processing may be, but is not limited to, KOH, NaOH, or tetra methyl ammonium hydroxide (TMAH).

When the pattern formed by the above-described process, the surface is conductively dry coated with a conductive material. The coating may be performed by any type of processing, such as wet coating and dry coating. The dry coating is advantageous for a more precise pattern. The coated surface is plated by electroforming. Upon completion of plating, a plate roller or a sheet is fabricated by separating a plating solution and a plated object. The electroforming may be repeatedly performed as required.

The printing mold completed by the above-described process is attached to the plate roller to be used in the roll-to-roll process later, or fabricates a negative film or a transparent conductive film in a negative film fabrication process or a transparent conductive film fabrication process.

After the printing mold is prepared in the above-described process, a negative film fabrication step using UV molding is performed.

The negative film fabrication step using UV molding is performed using an imprinting device for transferring the patterned surface shape of the printing mold to a film without a change in size.

Describing in more detail, before the first substrate 110 wound on the feed roller 15 is supplied to the plate roller 11 via one or more guide rollers 17a and 17b, a UV curable resin is injected between the first substrate 110 and the plate roller 11 using a resin injector 12, pattern imprinting is performed using the plate roller 11, and the imprinted pattern is exposed to light generated by a UV irradiator 41a, so that a negative film having a negative pattern is formed on the transparent substrate.

Conductive ink is applied on the fabricated negative film using an ink injector 13. Afterwards, residual conductive ink is removed from the negative film, on which conductive ink is applied, using a blade, as required.

After the conductive ink printing step S120, step S140 of layering a heat protection film of conductive fabric above the first pattern 140 and the drying step S150 are performed, thereby completely fabricating a heating sheet on one surface of the substrate.

A heat drying temperature of 100 to 200° C. and a drying time of 1 to 60 min may be suitable for the drying step S150.

The electrode fabrication step S130 is a step of fabricating electrodes 120 on the first pattern 140. The electrodes 120 are a positive (+) electrode 120b and a negative (−) electrode 120a, as described above. Although the electrode fabrication step S130 may be selectively added after the ink printing step S120, the electrodes may be fabricated after the heating sheets are fabricated on both the substrates.

In addition, the drying step S150 may be performed after the heating sheets are fabricated on both the substrates.

After the heating sheet is fabricated on one surface of the substrate in steps S110 to S150, step S200 of fabricating a heating sheet having the same pattern on one surface of a second substrate 111 is performed.

That is, when the fabrication of the heating sheet on the first substrate 110 is completed in step S100, step of fabricating the heating surface on one surface of the second substrate 111 is performed by inputting the second substrate 111 and using step S210 to step S250, which are repetitions of steps S110 to S150.

In addition, although it has been described in the detailed description that the planar heating element is fabricated by forming patterns on different substrates and bonding the substrates to each other, patterns may be formed on both surfaces of a single substrate, as described above.

In this case, in the roll-to-roll gravure device, a web turn bar for reversing and supplying a substrate to a process connected to the winding roller 16 may be disposed, such that the substrate can be reversed by the web turn bar before being supplied to another plate roller. In this manner, patterns can be fabricated on both surfaces of the substrate in a single process.

That is, in the case of pattern fabrication on both surfaces of the substrate, patterns may be fabricated on both surfaces of the substrate by supplying the substrate, which has the pattern fabricated thereon in the process of FIG. 16 and is wound on the winding roller 16, to a roll-to-roll gravure device the same as the device in FIG. 16. Alternatively, patterns may be continuously fabricated on both surfaces of the substrate using the web turn bar.

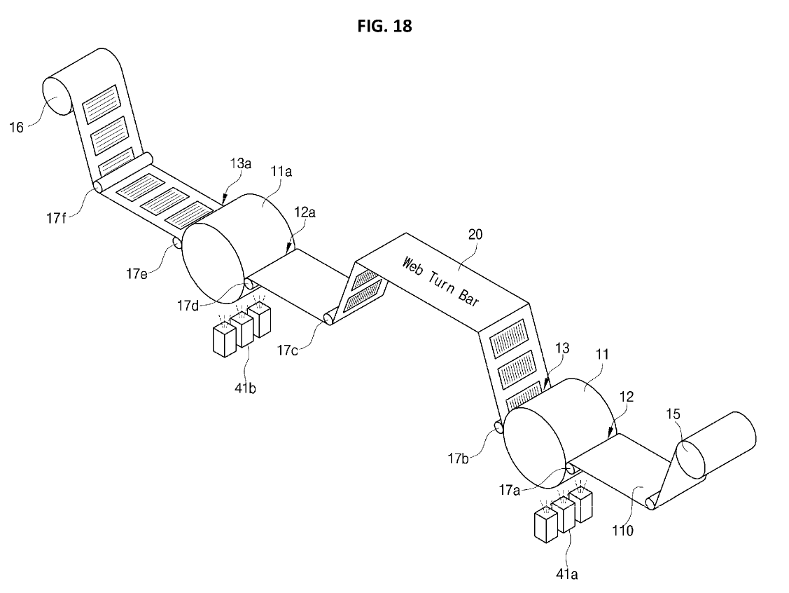

FIG. 18 illustrates another embodiment of the roll-to-roll gravure printing machine for fabricating a planar heating element according to the present invention. Referring to FIG. 18, a configuration for printing a heating line on one surface of a substrate and printing a heating line on the other surface of the substrate in a continuous process by supplying the substrate using a web turn bar 20 is provided.

The web turn bar 20 is configured to reverse the first substrate 110 so that a reversed pattern of the pattern printed on one surface of the substrate can be printed on the other surface of the substrate.

That is, the first substrate 110, reversed by the web turn bar 20, is supplied to a plate roller 11a provided with another embossed mold, via one or more guide rollers 17d, so that a pattern is printed on the other surface of the first substrate 110. The substrate with the patterns printed on both surfaces thereof is wound around a winding roller 16.

Hereinafter, the patterns are fabricated on both surfaces of the substrate by a conductive ink printing step of coating the surface of the substrate, reversed by the web turn bar 150, with a photosensitive agent and forming the pattern on the surface coated with the photosensitive agent by UV molding using UV exposure, in the same manner as in the method of fabricating the pattern on one surface of the substrate described above with reference to FIG. 16.

Specifically, after a positive printing mold is fabricated, the positive printing mold is connected to the plate roller 11a, a UV curable resin is injected between the provided first substrate 110 and the plate roller 11a using a resin injector 12a, and UV radiation is provided by a UV radiator 41b, so that a transparent planar heating element having negative patterns on the surfaces thereof is fabricated.

As described above, in the planar heating element for a refrigerator according to the present invention, the conductive ink according to the present invention may be implemented as one selected from among, but is not limited to, silver (Ag) nano ink, carbon nano ink, copper (Cu) ink, gold (Au) ink, aluminum (Al) paste, and conductive silver ink, since electric conductivity may vary depending on the type of ink and the control over the printing process. Since aluminum particles have a lower specific resistance with increases in the size thereof, aluminum particles having a greater radius may be used in terms of specific resistance. However, when aluminum particles have a greater radius, the surface formed using the aluminum particles may be porous. Accordingly, aluminum particles in the aluminum paste may have an average radius of 5 μm or less.

In addition, aluminum particles having a greater radius may be used. However, when aluminum particles have a greater radius, the surface formed using the aluminum particles may be porous. Accordingly, aluminum particles in the aluminum paste may have an average radius of 5 μm or less.

In particular, Al particles in the aluminum paste are arranged in a plurality of horizontal layers to provide a strong barrier against moisture penetration. Due to this feature the aluminum paste has high resistance to vapor and moisture and thus can be advantageously used for a heating element. A variety of figures may be used for the patterns, as required.

That is, since a fine line width can be obtained by negative printing and fine patterns (1 to 5 μm) can be uniformly printed on a large area, the patterns are not visually recognizable and transparency can be maintained.

In the present step, the electrode fabrication step S130 and S230 and the drying step S150 and S250 may be selectively applied according to each step. However, the electrode fabrication step and the drying step may be performed after the heating sheets are fabricated on the substrates.

When the heating sheets are fabricated on the substrates in step S10 and step S200, a planar heating element according to an embodiment of the present invention is completed by bonding the two substrates to each other (S300).

In step S300, the two substrates 110 and 111 are bonded to each other using an adhesive 112, such that the patterns of the substrates conform to each other, as described above.

Afterwards, the electrode terminals of the upper and lower substrates are connected by applying simple two-hole riveting to the electrodes of the bonded substrates, thereby completing the planar heating element according to the present invention (S400).

In addition, alternating current (AC) power may be applied to the electrodes, since the planar heating element according to the present invention uses reverse current print patterning technology.

The use of reverse current can effectively block magnetic waves. The use of conductive ink including carbon, silver, aluminum, or the like, to which an earth line can be connected, can block electric waves.

Hereinafter, test results of comparing current direction-specific magnetic fields measured from heating films fabricated by the above-described method will be described.

Table 2 represents measurements obtained from a heating film fabricated according to Example 1.

TABLE 2

| Standard | 400 × 600 | |
|---|---|---|
| Printing Method | Scree/Cross-section | |
| Specimen | Width/4.5 mm, Interval/3 mm, 1 Line | |
| Information | | |
| Applied Voltage | 220 V | |
| Fabrication Method | Two specimens used, Same electrode | |
| | positions, Same current directions | |
| Measured Position | Measured from | Measured from |
| | electrode portion | central portion |
| Measurement | Non-measurable | 10.67 mG |

In Example 1, a magnetic field was non-measurable from an electrode portion, since the value was high. When a magnetic field was measured from a central portion, a value 10.67 mG was obtained. To reduce these values, Example 2 was fabricated, and measurement was performed.

Table 3 represents measurements obtained from a heating film fabricated according to Example 2.

TABLE 3

| Standard | 400 × 600 | |
|---|---|---|
| Printing Method | Scree/Cross-section | |
| Specimen | Width/4.5 mm, Interval/3 mm, 1 Line | |
| Information | | |
| Applied Voltage | 220 V | |
| Fabrication Method | Two specimens used, Electrode positions | |
| | and current directions in opposite | |
| | before use | |
| Measured Position | Measured from | Measured from |
| | peripheral portion | central portion |
| Measurement | 0.59 mG | 0.48 mG |

In Example 2, when a magnetic field was measured from an electrode portion and a central portion, significantly-reduced values 0.59 mG and 0.478 mG were obtained. To further reduce these values, Example 3 was fabricated, and measurement was performed.

Table 4 represents measurements obtained from a heating film fabricated according to Example 3.

TABLE 4

| Standard | 400 × 600 | |
|---|---|---|
| Printing Method | Scree/Cross-section | |
| Specimen | Width/4.5 mm, Interval/3 mm, 1 Line | |
| Information | | |
| Applied Voltage | 110 V | |
| Fabrication Method | Two specimens used, Same electrode | |
| | positions, Intersecting current | |
| | directions | |
| Measured Position | Measured from | Measured from |
| | electrode portion | central portion |
| Measurement | 5.37 mG | 0.049 mG |

Referring to measurements obtained from Example 3, a magnetic field value measured from a central portion, except for an electrode portion, was 0.049 mG. It can be appreciated that the magnetic field was substantially entirely blocked in the central portion.

<<That is, as in the magnetic field shielding heating film according to the present invention, patterns are printed on the surfaces of substrates, respectively. Here, the same patterns are printed on a pair of substrates such that the pattern on one substrate overlaps the pattern on the other substrate, so that magnetic waves can be significantly reduced.

Hereinafter, a control method for a defrosting planar heating element and a control method for a planar heating element for a home bar will be described with reference to the drawings.

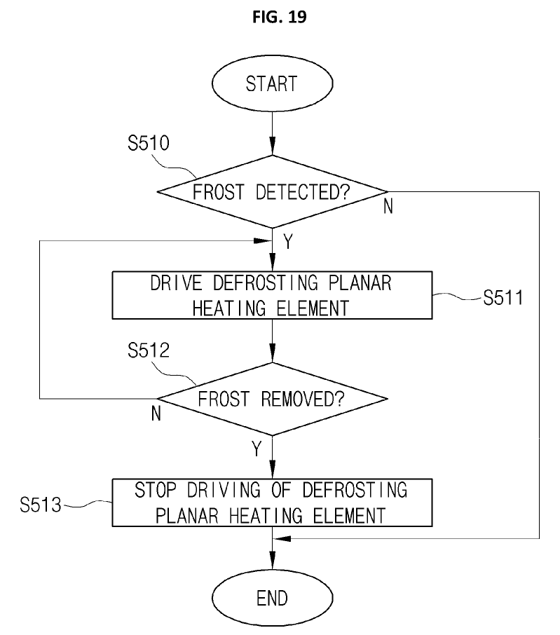

First, referring to a flowchart in FIG. 19, which illustrates a control method for a defrosting planar heating element according to the present invention, the controller 30 determines whether or not frost is detected by the frost detection unit 81 provided in the evaporator 15 (S510).

When frost is detected by the frost detection unit 81, the controller 30 controls the defrosting planar heating element 100 provided on the top and bottom of the evaporator 15 to generate heat (S511).

In step S511, the controller 30 controls the first driver 160, which drives the defrosting planar heating element 100, to apply electric power to the electrode terminals of the defrosting planar heating element 100.

After step S511, the controller 30 determines whether or not frost is detected by the frost detection unit (S512). When frost is detected, the controller 30 continuously controls the defrosting planar heating element 100 to generate heat. When it is determined that frost has been removed, the controller 30 controls the first driver 160, which drives the defrosting planar heating element 100, to stop the supply of electric power to the electrode terminals of the defrosting planar heating element 100 (S513).

Although the defrosting planar heating element may use the frost detection unit provided in the evaporator, the present invention is not limited thereto. Rather, the defrosting planar heating element may repeatedly generate heat and stop heat generation for predetermined periods.

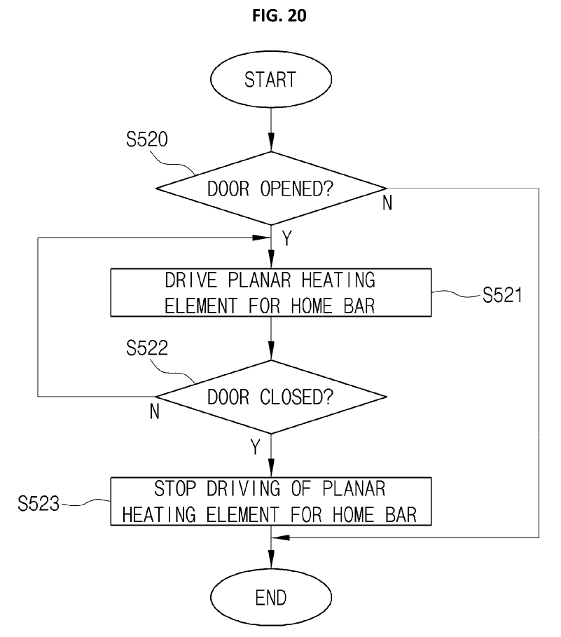

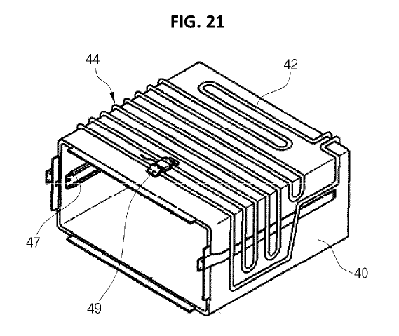

In addition, referring to a flowchart in FIG. 20, which illustrates a control method for a planar heating element for a home bar according to the present invention, the controller 30 determines whether or not a home bar door is opened using the home bar opening/closing sensor 674 provided in the home bar door (S520).

When the home bar door is detected as being opened by the home bar opening/closing sensor 674, the controller 30 controls the planar heating element 200 for a home bar, situated within the home bar case 673 or home bar support bracket, to generate heat to a predetermined temperature (S521).

In step S521, the controller 30 controls the second driver 260, which drives the planar heating element 200 for a home bar, to apply electric power to the electrode terminals of the planar heating element 200 for a home bar.

After step S521, the controller 30 determines whether or not the home bar door is closed using the home bar opening/closing sensor 674 (S522). When the home bar door is detected as being opened, the controller 30 continuously controls the planar heating element 200 for a home bar to generate heat. When the home bar door is detected as being closed, the controller 30 controls the second driver 260, which drives the planar heating element 200 for a home bar, to stop the supply of electric power to the electrode terminals of the planar heating element 200 for a home bar (S523).

In addition, in the control method for the planar heating element for a home bar, the planar heating element for a home bar may be configured to repeatedly generate heat and stop heat generation for predetermined periods without the use of the home bar opening/closing sensor 674.

While the present invention has been shown and described with respect to the specific embodiments, it will be understood by those skilled in the art that various changes and modifications may be made without departing from the spirit and scope of the present invention as defined in the appended Claims.

### INDUSTRIAL APPLICABILITY

The present invention relates to a planar heating element. The planar heating element used as a heat source in a refrigerator, in which generation of heat at a predetermined temperature is necessary to remove frost or prevent dew condensation, is fabricated by printed electronics technology.

1. A planar heating element for a refrigerator, the planar heating element being provided within the refrigerator to generate heat using electric power externally supplied by a power supply, the planar heating element comprising a defrosting planar heating element,
wherein the defrosting planar heating element comprises:
a first substrate having a first pattern printed on one surface thereof with conductive ink, the first pattern generating heat in response to electric power supplied by the power supply;
a second substrate having a second pattern printed on one surface thereof with conductive ink, the second pattern having a same configuration as the first pattern and generating heat in response to electric power supplied by the power supply; and
an adhesive layer bonding the first substrate and the second substrate to each other such that the pattern of the first substrate overlaps the pattern of the second substrate in a top-bottom direction.

2. The planar heating element according to claim 1, wherein the defrost planar heating element further comprises:
a first electrode comprising a positive (+) electrode electrically connected to one end of the first pattern and a negative (−) electrode electrically connected to the other end of the first pattern; and
a second electrode comprising a positive (+) electrode electrically connected to one end of second pattern and a negative (−) electrode electrically connected to the other end of the second pattern,
wherein the first electrode and the second electrode are provided in same positions of the first and second substrates, respectively.

3. The planar heating element according to claim 2, wherein the defrosting planar heating element is located on a top surface or a bottom surface of an evaporator, one end of the first pattern being connected to the positive (+) electrode of the first electrode, the other end of the first pattern extends along a shape of a bottom of the evaporator to be connected to the negative (−) electrode of the first electrode, one end of the second pattern being connected to the positive (+) electrode of the second electrode, and the other end of the second pattern extends along the shape of the bottom of the evaporator to be connected to the negative (−) electrode of the second electrode, wherein, when a portion of either a shape of the first substrate or a shape of the second substrate has an area able to accommodate two or more portions of the pattern, the portions of the pattern are alternately arranged without interruption.

4. The planar heating element according to claim 1, further comprising a planar heating element for a home bar,
wherein the planar heating element for the home bar comprises:
a third substrate having a third pattern printed on one surface thereof with conductive ink, the third pattern generating heat in response to electric power supplied by the power supply;
a fourth substrate having a fourth pattern printed on one surface thereof with conductive ink, the fourth pattern having a same configuration as the third pattern and generating heat in response to electric power supplied by the power supply; and
an adhesive layer bonding the third substrate and the fourth substrate to each other such that the pattern of the third substrate overlaps the pattern of the fourth substrate in a top-bottom direction.

5. The planar heating element according to claim 4, comprising:
a third electrode comprising a positive (+) electrode electrically connected to one end of the third pattern and a negative (−) electrode electrically connected to the other end of the third pattern; and
a fourth electrode comprising a positive (+) electrode electrically connected to one end of fourth pattern and a negative (−) electrode electrically connected to the other end of the fourth pattern,
wherein the third electrode and the fourth electrode are provided in same positions of the third and fourth substrates, respectively.

6. The planar heating element according to claim 5, wherein the planar heating element for a home bar is cut in a shape in which outer shapes of the third substrate and the fourth substrate conform to a shape of a support bracket provided on a rear side of the home bar and the planar heating element surrounds a portion of a top surface, a portion of a bottom surface, and a rear surface of the support bracket, the planar heating element for a home bar being situated within the support bracket, one end of the third pattern being connected to the positive (+) electrode of the third electrode, the other end of the third pattern extends along the shape of the support bracket to be connected to the negative (−) electrode of the third electrode, one end of the fourth pattern being connected to the positive (+) electrode of the fourth electrode, and the other end of the fourth pattern extends along the shape of the support bracket to be connected to the negative (−) electrode of the fourth electrode, wherein, when a portion of either a shape of the third substrate or a shape of the fourth substrate has an area able to accommodate two or more portions of the pattern, the portions of the pattern are alternately arranged without interruption.

7. The planar heating element according to claim 5, wherein the first pattern, the second pattern, the third pattern, and the fourth pattern are printed using a roll-to-roll gravure printing machine,
wherein the roll-to-roll gravure printing machine comprises:
a feed roller supplying a rolled substrate;
a plate roller printing a negative pattern on one surface of the substrate supplied by the feed roller; and
an ink injector applying conductive ink on the negative pattern produced by the plate roller.

8. A planar heating element for a refrigerator, the planar heating element being provided within the refrigerator to generate heat using electric power externally supplied by a power supply, the planar heating element comprising a defrosting planar heating element,
wherein the defrosting planar heating element comprises:
a first pattern printed on one surface of a first substrate with conductive ink, the first pattern generating heat in response to electric power supplied by the power supply; and
a second pattern printed on the other surface of the first substrate with conductive ink, the second pattern having a same configuration as the first pattern.

9. The planar heating element according to claim 8, wherein the defrosting planar heating element further comprises:
a first electrode comprising a positive (+) electrode electrically connected to one end of the first pattern and a negative (−) electrode electrically connected to the other end of the first pattern; and
a second electrode comprising a positive (+) electrode electrically connected to one end of second first pattern and a negative (−) electrode electrically connected to the other end of the second pattern,
wherein the first electrode and the second electrode are provided in same positions of the first substrate.

10. The planar heating element according to claim 8, further comprising a planar heating element for a home bar, wherein the planar heating element for the home bar comprises:
a third pattern printed on one surface of a second substrate with conductive ink, the third pattern generating heat in response to electric power supplied by the power supply; and
a fourth pattern printed on the other surface of the second substrate with conductive ink, the fourth pattern having a same configuration as the third pattern.

11. The planar heating element according to claim 10, wherein the planar heating element for the home bar further comprises:
a third electrode comprising a positive (+) electrode electrically connected to one end of the third pattern and a negative (−) electrode electrically connected to the other end of the third pattern; and
a fourth electrode comprising a positive (+) electrode electrically connected to one end of fourth pattern and a negative (−) electrode electrically connected to the other end of the fourth pattern,
wherein the third electrode and the fourth electrode are provided in same positions of the second substrate.

12. The planar heating element according to claim 11, wherein the first pattern, the second pattern, the third pattern, and the fourth pattern are printed using a roll-to-roll gravure printing machine,
wherein the roll-to-roll gravure printing machine comprises:
a feed roller supplying a rolled substrate;
a first plate roller printing a negative pattern on one surface of the substrate supplied by the feed roller;
a first ink injector applying conductive ink on the negative pattern produced by the first plate roller;
a second plate roller printing a negative pattern on the other surface of the substrate supplied by the feed roller in a reversed position; and
a second ink injector applying conductive ink on the negative pattern produced by the second plate roller.

13. The planar heating element according to claim 8, wherein each of the first and second patterns is configured to be broken when the first substrate thermally deflects.

14. A heating control method for a planar heating element for a refrigerator, the heating control method removing frost by driving the planar heating element according to whether or not frost is detected by a frost sensor, and comprising:
(a) a step of detecting, by the frost sensor, frost;
(b) a step of causing, by a controller, a defrosting planar heating element provided in an evaporator to generate heat when frost is detected in the (a) step; and
(c) a step of stopping heat generation of the defrosting planar heating element when frost is detected as being removed by the frost sensor after the (b) step.

15. The heating control method of claim 14, further comprising:
(a) a step of detecting, by the home bar opening/closing sensor, opening of the home bar door;
(b) a step of causing, by a controller, a planar heating element for a home bar situated within a home bar support bracket to generate heat when the home bar door is detected as being opened in the (a) step; and
(c) a step of stopping heat generation of the planar heating element for a home bar when the home bar door is detected as being closed by the home bar opening/closing sensor after the (b) step.

16. The planar heating element according to claim 1, wherein the first pattern is configured to be broken when the first substrate thermally deflects, and the second pattern is configured to be broken when the second substrate thermally deflects.
